(19) United States
(12) Patent Application Publication
(10) Pub. No.: US 2022/0356722 A1
(43) Pub. Date: Nov. 10, 2022

(54) REPAIR KIT FOR TEXTURED BUILDING SURFACES, AND RELATED METHODS OF USE

(71) Applicant: 3M INNOVATIVE PROPERTIES COMPANY, St. Paul, MN (US)

(72) Inventors: Joseph A. Hoffman, Minneapolis, MN (US); Thomas W. Floyd, St. Paul, MN (US); Megan K. Tuetken, St. Paul, MN (US)

(21) Appl. No.: 17/764,578

(22) PCT Filed: Oct. 9, 2020
(86) PCT No.: PCT/IB2020/059521

§ 371 Date: Mar. 29, 2022

Related U.S. Application Data
(60) Provisional application No. 62/914,131, filed on Oct. 11, 2019.

(51) Int. Cl. E04G 23/02; B29C 73/02; B29C 73/30; B29C 33/38; B29C 37/00; B29C 33/68

(52) U.S. Cl. CPC E04G 23/0203; B29C 73/025; B29C 73/30; B29C 33/3857; B29C 37/0075; B29C 33/68; B29L 2031/10

(57) ABSTRACT

The present disclosure is directed towards a kit for approximating texture of a building surface (e.g., a wall or ceiling). The kit can include a repair compound, a texture holding material, and optionally one or material to textured more pressing and shaping tools. The texture holding compound can be used to create a mold or stamp of surface texture in a non-damaged area of the building surface needing repair. The texture mold can be used to impart consistent surface texture to the repair compound as it dries, allowing a repaired area to at least approximate the texture of the area of the building surface surrounding the repaired area. The tool, if provided, can include a planar surface that can be used to conform the texture holding material to the surface texture, maintain contact between the texture mold and the repair compound to impart the mimicked texture, or both.

### TECHNICAL FIELD

The present disclosure relates generally to materials such as paste or putties, often referred to as repair or spackling compounds, which are used to fill and repair holes, cracks and other minor surface defects or imperfections in wood, drywall, and/or plaster.

### BACKGROUND

In the construction of buildings and residential remodeling, one of the most common elements is gypsum wallboard, often known as drywall, used in the construction of walls and/or ceilings. When cavities, cracks, recesses, holes, etc., are present (due to imperfections or damage), it is common to use a repair compound, and in particular a spackling compound, to fill such undesirable aspects. Conventional spackling compounds often include one or more inorganic fillers, one or more polymeric resin binders, and various thickeners and other additives. Lightweight spackling compounds have been developed that often contain, among other inorganic fillers, relatively low-density fillers such as glass bubbles, hollow silica, or expanded perlite. After the spackling compound is applied to a wall, the water evaporates over a period of time resulting in the formation of a dried, hardened material that can be sanded, painted, etc. Another, similar type of repair compound is known as a joint compound typically used to conceal the joint between adjacent wallboards. While spackling compounds and joint compounds do many of the same things and are both smeared onto walls to hide flaws, spackling compounds are generally lighter, dry more quickly, sand more easily, and are more expensive than joint compounds. For simplicity, the term “repair compound” as used throughout the present disclosure is inclusive of spackling compounds and joint compounds.

Spackling compounds are known in the art. U.S. Pat. No. 6,531,528 (Kurp), for example, discloses a ready-to-use patch repair product that includes a color change indicator. After the product has dried, the color changes to signal that, if desired, the user can perform other operations such as painting, sanding, etc., on the surface. U.S. Pat. No. 7,790,796 (Foster et al.) discloses a spackling compound that it easy to apply smoothly, can be applied in thicker layers than known spackling compounds without cracking upon drying, and can be modified after drying without pitting, flaking, or crumbling, particularly at the edges of the applied spackling patch. U.S. Pat. No. 8,877,840 (Gozum et al.) discloses a self-priming spackling compound. U.S. Pat. No. 10,273,185 (Gozum et al.) discloses a repair compound including a latex resin, a thickener, fibers, and a filler material. The fiber-containing compounds exhibit pseudoplastic behavior and are well-suited for large hole or horizontal surface repair. International Publication No. WO2019040601 describes repair compounds generally include a latex resin, a thickener package, fibers, and a synthetic filler material (e.g., glass bubbles). Such compounds demonstrate at least one of a low viscosity under large stress to make application easy, a high viscosity under low stress to prevent creeping flow after application, and yield stress behavior to resist sagging or running after application.

### SUMMARY

The inventors of the present disclosure recognized that while conventional repair compounds are adequate for repairing imperfections or holes, they generally result in planar, repaired surfaces that do not match or even approximate the texture and appearance of the surrounding wall or ceiling. Though the surface is ostensibly repaired, the mismatched aesthetics serve as constant reminder of prior damage. This problem is particularly exacerbated with popular textures (e.g., knockdown ceilings or stippled wall/ceilings) and large holes, as the eye is commonly drawn to the surfaces clearly lacking the expected texture.

Some aspects of the present disclosure are directed toward a kit for approximating texture of a building surface (e.g., a wall or ceiling). In some embodiments, the kit includes a repair compound, a texture holding compound, and optionally one or more pressing and shaping tools. The texture holding compound can be used to create a mold or stamp of surface texture in a non-damaged area of the building surface needing repair. The texture mold can be used to impart consistent surface texture to a repair compound as it dries, allowing the repaired area to mimic or at least approximate the texture of the area of the building surface surrounding the repaired area. The tool, if provided, includes a planar surface that can be used to conform the texture holding material to the surface texture, maintain contact between the texture mold and the repair compound to impart the mimicked texture, or both. The kit may optionally include one or more release liners. Release liners may be placed between the tool (or other planar surface) and texture holding compound during mold creation and/or between the texture mold and the repair compound. Use of release liners can ease removal and separation of the tool or the mold from the building surface without material disruption of the texture pattern.

Other aspects of the present disclosure are directed toward a method of repairing a hole in a substrate. The method includes receiving a volume of a hardenable texture holding material and a repair compound described above. A quantity of the hardenable texture holding material is applied to an undamaged, textured area of a building surface (e.g., a wall or ceiling). Pressure is applied in the direction of the building surface and the texture holding material is allowed to harden to form a texture mold. The mold is then removed, typically by peeling, from the building surface. A quantity of the repair compound is applied into the hole, optionally with a tool to smooth the outer surface and bridge the hole with the surrounding area. As the repair compound dries, the texture mold is pressed into the outward facing surface, transferring the texture of the mold to the outward facing surfaces of the repair compound. At any stage, a release liner may be placed between disparate elements to aid in separation and removal.

As used herein, “hardenable” is descriptive of a material or composition that can be cured (e.g., polymerized or crosslinked) or solidified, for example, by removing solvent (e.g., by evaporation and/or heating); heating to induce polymerization and/or crosslinking; cooling to solidify; irradiating to induce polymerization and/or crosslinking; and/or by mixing one or more components to induce polymerization and/or crosslinking. “Mixing” can be performed, for example, by combining two or more parts and mixing to form a homogeneous composition. Alternatively, two or more parts can be provided as separate layers that intermix (e.g., spontaneously or upon application of shear stress) at the interface to initiate polymerization.

As used herein, “hardened” refers to a material or composition that has been cured (e.g., polymerized or crosslinked) or solidified.

As used herein, the terms, “height”, “depth”, “top” and “bottom” are for illustrative purposes only, and do not necessarily define the orientation or the relationship between the surface and the intrusive feature. Accordingly, the terms “height” and “depth”, as well as “top” and “bottom” should be considered interchangeable.

As used herein, the terms “comprises” and variations thereof do not have a limiting meaning where these terms appear in the description and claims.

As used herein, the words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a”, “an”, “the”, “at least one”, and “one or more” are used interchangeably. Thus, for example, a kit comprising “a” repair compound can be interpreted as a kit comprising “one or more” repair compounds.

Also herein, the recitations of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

FIG. 1 is a process diagram of a method for repairing a textured building surface, according to embodiments of the present disclosure;

FIG. 2 is a photograph of a textured wall surface with a hole in need of repair;

FIG. 3 is a photograph of a hardenable texture holding material applied to the textured wall surface in an undamaged area adjacent the hole;

FIG. 4 is a photograph of a tool with a planar surface applying force to the hardenable texture holding material in the direction of the wall surface;

FIG. 5 is a photograph of the hardenable texture holding material hardened to form a texture mold;

FIG. 6 is a photograph of a quantity of repair compound prepared to apply to the hole;

FIG. 7 is a photograph of the repair compound applied and smoothed over the hole and surrounding wall surface;

FIG. 8 is a photograph of a tool with a planar surface applying force to the texture mold and the outward facing surface of the repair compound; and

FIG. 9 is a photograph of the repair area of the wall, with the outward facing surface of the repair compound at least approximating the texture of the surrounding wall.

### DETAILED DESCRIPTION

Various embodiments and implementations will be described in detail. These embodiments should not be construed as limiting the scope of the present disclosure in any manner, and changes and modifications may be made without departing from the spirit and scope of the inventions. For example, many of the embodiments, implementations, and examples are discussed with specific reference to wall repair, but these should not be construed to limit the application scope to this one exemplary implementation. Further, only some end uses have been discussed herein, but end uses not specifically described herein are included within the scope of the present disclosure. As such, the scope of the present disclosure should be determined by the claims.

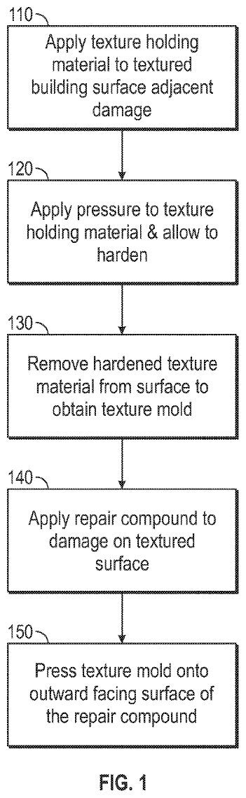

The present disclosure provides methods, materials and tools for repairing holes in textured building surfaces such that the repaired region is virtually non-detectable in context. FIG. 1 sets out a process for creating a texture mold and using that mold to recreate texture in a repaired surface. First, a quantity of the hardenable texture holding material is applied to an undamaged, textured area of a building surface (e.g., a wall or ceiling) (Step 110). Pressure is applied, typically with aid of a tool or other article with a planar surface, in the direction of the building surface and the texture holding material is allowed to harden to form a texture mold (Step 120). A release liner may be placed between the planar surface applying pressure and hardenable material. The hardened mold is then removed, typically by peeling, from the textured building surface (Step 130). A quantity of the repair compound is applied onto or into the damaged area (Step 140), optionally with a tool to smooth the outer surface and bridge the hole with the surrounding area. As the repair compound dries, the texture mold is pressed into the outward facing surface, transferring the texture of the mold to the outward facing surfaces of the repair compound. (Step 150). As with Step 120, a release liner may be placed between a textured surface of the texture mold and the repair compound.

FIG. 2 depicts a building surface 10, in this case representing a wall, including a surface texture 11 and a damaged region 20 featuring a hole 21 through the wall. The hole 21 includes a perimeter 22 and depth relative to an average elevation of the wall surface 10. The surface texture 11 include protrusive features 12, defining recesses 13 between the protrusive features. The surface texture 11 is merely representative, and any other surface texture (including those lacking protrusive features) would still be suitable for repair with the methods and materials of the present disclosure.

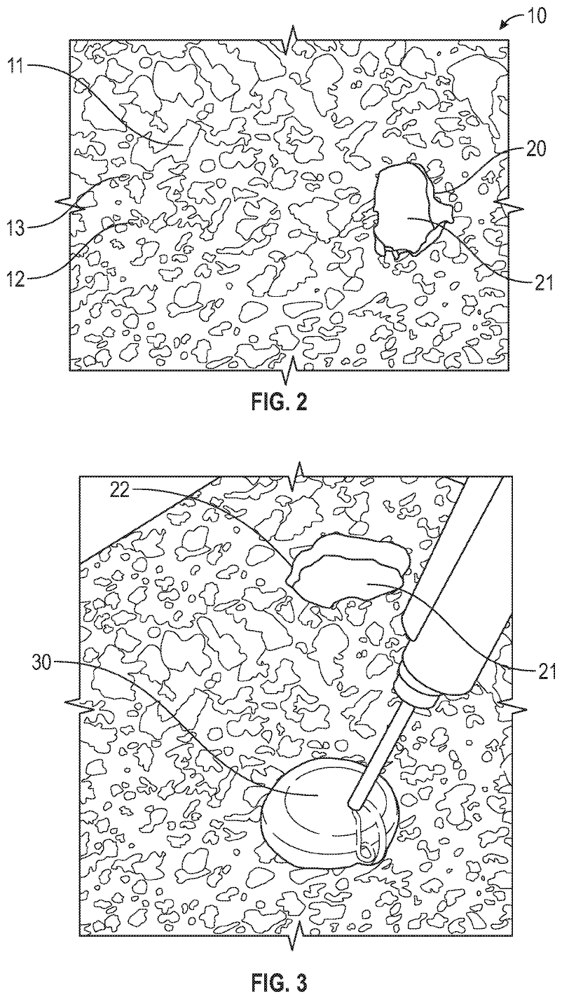

FIG. 3 shows a hardenable texture holding material 30 applied via syringe-type device to a textured area of the wall adjacent the hole 21. The amount of texture holding material dispensed or otherwise applied to the surface is an amount sufficient for the resulting mold to have an area greater than the damaged area (e.g., having dimensions greater than the perimeter 22 of the hole 21). Typically, the area covered by the hardenable material as initially applied will approximate the dimensions of the perimeter 22. The hardenable texture holding materials are typically soft and flowable before hardening to conform to the texture features, but then harden enough to hold an impression of the texture features into a surface of the material. Suitable texture holding materials can harden over relative short time periods (e.g., about 3 minutes to about 15 minutes) and are resistant to sagging or creep during and after hardening. Furthermore, suitable texture holding materials do not substantially, inelastically deform upon removal from the textured surface and typically demonstrate high (at least 90%) recovery from deformation. In presently preferred implementations, the hardenable texture holding material is still sufficiently soft in its hardened condition to conform to the existing texture surrounding the damage in order to aid in aesthetic transition from the mold texture to the surrounding wall.

The texture holding materials typically have tear strengths (i.e., tensile strength) between about 2.1 and about 8 MPa, and more commonly between about 2.4 and about 5 MPa. Generally, holding materials with tear strength values between about 2.1 and about 6 MPa, and especially between about 2.4 and about 5 MPa, allow easy removability of the cured and texture imprinted material from the building surface without compromising details (e.g., texture pattern) of the mold.

Suitable texture holding materials include dental impression materials. A dental impression material can be based on different chemical substances and crosslinked by various chemical reactions (including addition curing and condensation curing materials). Dental impression materials can be classified according to their curing mechanism (e.g., addition curing or condensation curing). Dental impression materials can also be classified according to their consistency. Besides low viscous dental impression materials, there exists highly viscous, so-called putty like dental impression materials. Examples of dental impression material include materials based on alginate(s), hydrocolloids, polysulfides, polyether technology, addition curable silicone materials (e.g., VPS materials) and condensation curable silicone materials. Dental impression materials are typically provided as two component systems that consist of a base paste and a catalyst paste and which are mixed prior to their application. The mixed pastes are typically applied with the help of syringe-type device.

Dental impression material are typically characterized by at least one, more or all of the following features: Consistency (according to ISO 4823): comparable low viscosity behavior (consistency 3), a medium viscosity (consistency 1 or 2) or putty-like, highly viscous behavior (consistency 0); Setting time: within about 15 min after mixing at ambient conditions (e.g., 23° C.); Shore A hardness (according to ISO 4823; 24 h): at least about 20 or at least about 40; Tensile strength (according to DIN 53504): at least about 0.2 MPa or at least about 3.0 MPa; Elongation at break (according to DIN 53504): at least about 30% or at least about 150% or at least about 200%; Recovery from deformation (according to ISO 4823): at least about 90% or at least about 95% or at least about 98%. Suitable dental impression materials are also described in EP2072029 (Bissinger et al.), U.S. Pat. No. 6,677,393 (Zech et al.), EP1512724 (Zech et al.), U.S. Pat. No. 6,127,449 (Lechner et al.), U.S. Pat. No. 8,007,579 (Klettke et al.) and U.S. Pat. No. 5,569,691 (Guggenberger et al.). Suitable dental impression materials are commercially available, e.g., from 3M ESPE under the brands Impregum™ or Imprint™, as well as myriad other suppliers and brands.

Presently preferred implementations of the present disclosure include the VPS impression materials described in U.S. Pat. Nos. 7,968,645 and 8,318,831 (each to Zech et al.), particularly those with higher viscosities (consistency 1 or 0) and swift setting time (about 3 minutes, or preferably less than 10 minutes).

In other viable embodiments, the texture holding material is a liquid silicone rubber (LSR). Suitable LSRs can have similar viscosities and setting time to the dental impression materials above. For instance, LSRs useful as texture holding materials have a viscosity at 10 s-1, Pa·s of at least 160, as measured by CTM 1094, or in other embodiments at least 180. LSRs may be provided in two or more parts that can be mixed to effectuate the curing process, typically by a platinum catalyst. In presently preferred implementations, the LSRs cure at relatively low curing temperatures (e.g., less than 130 C) or those that cure at ambient temperatures. Exemplary LSRs includes those sold under the SILASTIC brand, particularly the 9300 and 9400 series, from The Dow Chemical Company. Others include LSRs sold under the LIVEO brand by DuPont de Nemours Inc, and those sold under the LIM or SILOPREN brands from Momentive Performance Materials.

Other suitable texture holding materials can include modeling clay, conformable foam, other moldable silicone material (e.g., SILLY PUTTY, available from Crayola, Inc.), and sprayable, rubber-based sealants. Other suitable texture holding materials include a mixture of equal parts silicone caulk (e.g., GE Advanced All Purpose Silicone Caulk) and cornstarch, as well as a mixture of vinegar and milk. In some embodiments featuring alternative texture holding materials such as modeling clay or LSRs, the material may be heated to a temperature above ambient before being pressed onto the building surface to soften and improve the conformability of the material.

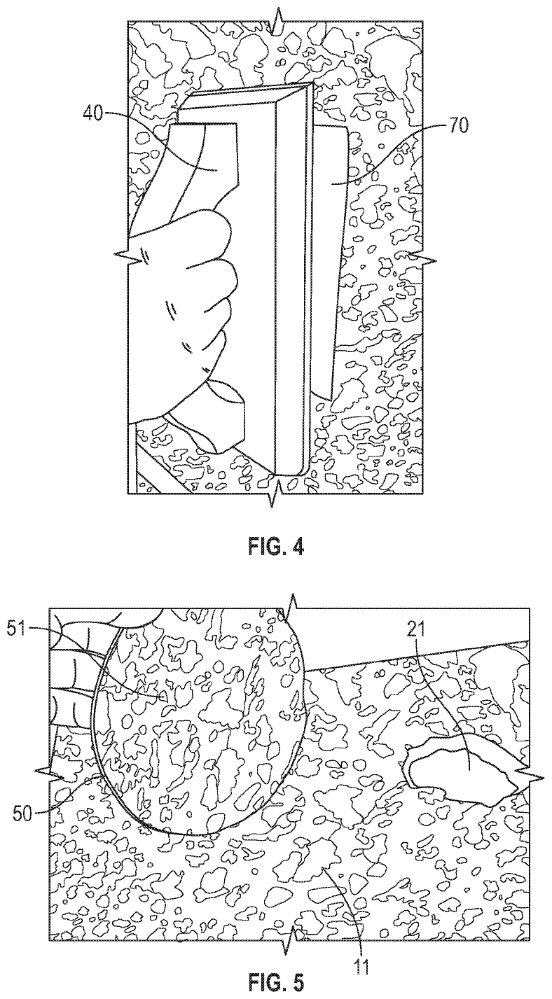

Next, and as shown in FIG. 4, the quantity of hardenable texture holding material 30 can be pressed onto the textured wall using a planar surface tool 40 to apply pressure in the direction of the wall. The planar surface can be part of an abrasive hand tool, as depicted, or may be provided by a book, board, or any other article having a flat surface large enough to cover hole 21. Pressure can be applied for a brief period of time (e.g., 30 seconds) until the texture holding material radially expands over the wall surface. Once hardened, the newly formed texture mold 50 can be removed from the wall surface. (FIG. 5). In presently preferred implementations, the texture mold is removed by peeling at a peel angle greater than about 35 degrees, as this typically allows the mold to retain an impression of the desired building material texture. The texture mold 50 will accordingly include, upon removal, a textured major surface 51 that approximates or mimics the texture 11 of the corresponding wall surface.

In typical circumstances, a release liner 70 is disposed between the planar surface and the texture holding material to aid in separation and removal. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048. Presently preferred release liners include fluoroalkyl silicone polycoated papers and LDPE or PVC food wraps, such as SARAN wrap, available from SC Johnson. Typically, paper or more rigid film is used as a liner in creating the mold in Step 120. The release liners can be printed with lines, brand indicia, or other information.

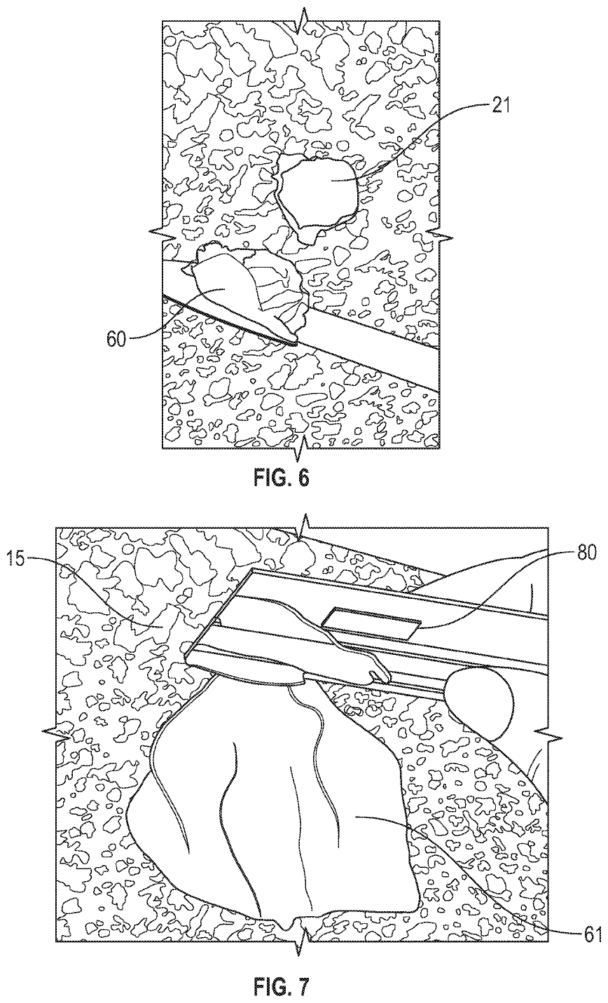

With a texture mold created, the repair methods of the present disclosure proceed to filling the damaged area with a repair compound 60, as depicted in FIGS. 6 and 7. The repair compound 60 can be applied in a manner consistent with conventional spackling compounds, including the user spreading a quantity of the repair compound into the hole and along the wall surface surrounding the hole with a spreading tool 80. In other embodiments, the repair compound can be provided to a user with a reduced water content (akin to a dough material). The corresponding methods of use would include the user rolling a volume of the dough-like repair compound to shape with the user's hand(s), and then inserting and pressing the shaped compound into the hole, with the option to further smooth with a spreading tool or the like. Regardless of application method, the repair compound 60 as set in the building material (i.e., wall or ceiling) presents an outwardly facing surface 61 that is generally coplanar with the surrounding surfaces 15.

Suitable repair compounds typically include a resin, filler, and a thickener and include those described above in U.S. Pat. No. 6,531,528 (Kurp), U.S. Pat. No. 7,790,796 (Foster et al.), U.S. Pat. No. 8,877,840 (Gozum et al.). U.S. Pat. No. 10,273,185 (Gozum et al.), and International Publication No. WO2019040601 (Gozum et al.). Suitable exemplary repair compounds are commercially available as 3M Patch Plus Primer 4 in 1 Spackling Compound and 3M Wall Repair Fiber Reinforced Compound, each available from 3M Company. Other suitable repair compounds for use with the present disclosure include DryDex Spackling, available from DAP Products, Inc. The repair compound used is not critical, so long as the compound allows a sufficient open time for imprinting the texture from the texture mold. Presently preferred repair compounds are sufficiently viscous and/or pseudoplastic to resist at least one of sagging or running when applied, such that they are suitable for large damaged areas or ceilings.

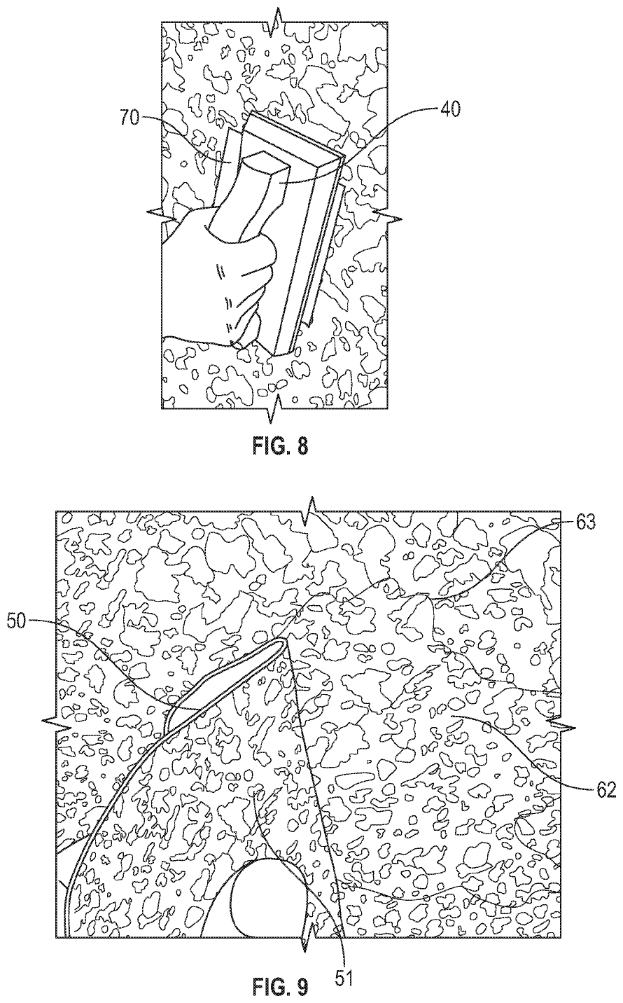

Once the repair compound 60 is seated and spread across the damaged area, the textured surface 51 of the texture mold 50 may be pressed against the outwardly facing surface 61. (FIG. 8). A release liner 70 may be placed between the textured surface 51 and the repair compound 60 to improve separability. The texture mold 50 can be pressed onto the outwardly facing repair compound surface 61 using a planar surface tool 40 (which can be the same or different as the tool or surface used in Step 120 above) to apply force in the direction of the wall. The applied force drives the textured surface 51 into the repair compound 60, recreating the texture or pattern held within the mold 50 on the outward facing surface 61. Typically, the imprinting or stamping of the mold texture onto the outwardly facing surface 61 occurs before the repair compound has dried or otherwise hardened. The force can be applied for any desired amount of time, but typically for at least 30 seconds.

As can be seen in FIG. 9, the imprint of the texture from the mold 50 results in a repaired surface 62 that is generally indistinguishable from the surrounding surfaces of the building material. To further reduce any aesthetic distinction, the perimeter 63 of the repaired surface may be manipulated during the drying period in order to fine-tune the transition between the repaired area and the surrounding surface. The manipulation may be performed with finger pressure or may be done with a dowel or other hand tool.

In some embodiments, the materials of the present disclosure can be provided to an end user as part of a kit. Exemplary kits can include a texture holding material, a repair compound, optionally one or more release liners, and optionally one or more shaping or planar surface tools.

The repair kits, materials, and methods of the present disclosure can be employed to aesthetically repair a plethora of wall surface imperfections or defects (e.g., holes, cracks, etc.). Further, repair kits, materials, and methods of the present disclosure are well-suited to be applied into a larger hole (e.g., hole with a major dimension of at least 2 inches) in a vertical wall surface (e.g., following placement of a backing material or panel onto a backside of the wall in a region of the hole) or a horizontal ceiling.

The recitation of all numerical ranges by endpoint is meant to include all numbers subsumed within the range (i.e., the range 1 to 10 includes, for example, 1, 1.5, 3.33, and 10).

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. A kit for approximating texture of a building material surface, the kit comprising
a repair compound, a texture holding material, and optionally one or more pressing and shaping tools.

2. The kit of claim 1, wherein the texture holding material is a hardenable material.

3. The kit of claim 2, wherein the texture holding material is a dental impression material.

4. The kit of claim 3, wherein the dental impression material is provided as two component systems including a base paste and a catalyst paste that are mixed prior to application.

5. The kit of claim 3, wherein the dental impression material is a VPS material.

6. The kit of claim 1, wherein the texture holding materials has a tear strength between about 2.1 and about 8 MPa.

7. The kit of claim 1, wherein the texture holding material has a Consistency of 1 or 0.

8. The kit of claim 1 and further including one or more release liners.

9. The kit of claim 1, wherein the kit includes a planar surface tool configured to apply pressure in the direction of a building material surface.

10. The kit of claim 1, wherein the repair compound includes a resin, a thickener, filler material, and fibers.

11. A method for repairing a building surface having a texture and a damaged area, the method comprising
providing a volume of a hardenable texture holding material;
applying the quantity of the hardenable texture holding material is applied to an undamaged, textured area of the building surface;
applying force to the quantity of hardenable texture holding material in the direction of the building surface;
allowing the texture holding material to harden to form a texture mold having a textured surface;
removing the mold from the building surface;
applying a quantity of a repair compound to the damaged area; and
pressing the textured surface of the texture mold against an outwardly facing surface of the repair compound, whereby the texture of the textured surface is transferred to the outwardly facing surface of the repair compound.

12. The method of claim 11, wherein the texture holding material is a dental impression material.

13. The method of claim 11, wherein the texture holding materials has a tear strength between about 2.1 and about 8 MPa, and a Consistency of 1 or 0.

14. The method of claim 11, wherein at least one of the steps of (a) applying force to the quantity of hardenable texture holding material, and (b) pressing the textured surface of the texture mold against an outwardly facing surface of the repair compound includes the use of a planar surface.

15. The method of claim 14, and further comprising inserting a release liner between the hardenable texture holding material and the planar surface.

16. The method of claim 11 and further comprising inserting a release liner between the texture mold and the repair compound.

17. The method of claim 11, wherein the removing the mold from the building surface includes peeling the mold from building surface.

18. The method of claim 17, wherein peeling the mold from the surface does not substantially deform the textured surface.

19. The method of claim 11, wherein applying the hardenable texture holding material includes the mixing of two paste components prior to the application.
